(19) United States
(12) Patent Application Publication
(10) Pub. No.: US 2008/0156358 A1
(43) Pub. Date: Jul. 3, 2008

(54) DISHWASHER AND RACK ASSEMBLY THEREFOR

(76) Inventors: Gap Su SHIN, Seoul (KR); Nung Seo Park, Seoul (KR); Yong Jin Choi, Seoul (KR); Young Hwan Park, Seoul (KR)

Correspondence Address: KED & ASSOCIATES, LLP, P.O. Box 221200, Chantilly, VA, 20153-1200, US

(21) Appl. No.: 11/954,633

(22) Filed: Dec. 12, 2007

(30) Foreign Application Priority Data
Dec. 29, 2006 (KR) 10-2006-0138627
Dec. 29, 2006 (KR) 10-2006 0138628

(51) Int. Cl. B08B 13/00; A47L 15/50

(52) U.S. Cl. 134/137; 211/41.8

(57) ABSTRACT

A dish washer capable of washing dishes of various sizes is provided. The dishwasher includes a rack assembly having a plurality of dish holders into which dishes may be inserted and by which the dishes supported are separated from each other on the rack assembly. The plurality of dish holders includes first and second dish holders having different heights disposed adjacent to one another.

This application claims priority to Korean Patent Application Nos. 10-2006-138627 and 10-2006-138628 filed in Korea on Dec. 29, 2006, the entire contents of which are hereby incorporated by reference.

### BACKGROUND

1. Field

A dishwasher and a rack assembly therefor are disclosed herein.

2. Background

In general, a dishwasher is an apparatus that washes away food residue attached to dishware, such as bowls, spoons, chopsticks, and various culinary tools (hereinafter, referred to as “dishware” or “dishes”) using a detergent and wash water. A washing tub or space having a cavity of a predetermined size is provided in the dishwasher. One or more rack assembly may be provided and configured to be inserted into and withdrawn from the washing tub. The rack assembly may include one or more dish holder(s) on which dishes are placed. The dish holder(s) may be provided in the rack assembly in various shapes according to kinds and sizes of the dishes. Moreover, a wash water spraying apparatus that sprays wash water onto the dishes placed in the rack assembly is provided in the washing tub. After the dishes are placed in the dish holder(s) of the rack assembly, the rack assembly is pushed into the washing tub. Then, the wash water spraying apparatus sprays the wash water at high pressure onto the rack assembly to wash the dishes.

The dishes may include a plurality of cutleries and culinary tools that are narrow and long. The cutleries may include, for example, a knife, a spoon, and a fork. The culinary tools may include, for example, a ladle, a kitchen knife, and a turner. A plurality of cutleries and culinary tools may be placed into the rack assembly.

However, in the related art dishwasher, since only specific dishes can be arranged in a single dish holder, the related art dishwasher is limited to washing such specific dishes. If various dish holders are provided in the rack assembly in order to solve this problem, the space efficiency of the rack assembly is reduced.

In other words, in order to wash various dishes in dishwasher, the rack assembly must have various type dish holders. However, it is practically impossible to provide various type dish holders in the rack assembly of a restricted size and it is very inefficient to use the dishwasher. That is, when the various type dish holders are provided in the rack assembly, the number of the dishes to be washed by the dishwasher at once is limited. In other words, the space efficiency of the rack assembly is deteriorated, and the capacity of the dishwasher is substantially decreased.

### BRIEF DESCRIPTION OF THE DRAWINGS

Embodiments will be described in detail with reference to the following drawings in which like reference numerals refer to like elements, and wherein:

FIG. 1 is a front perspective view of a dishwasher according to an embodiment;

FIG. 2 is an exploded perspective view of a frame of a rack assembly and baskets of the dishwasher of FIG. 1;

FIG. 3 is an enlarged perspective view of a portion “A” of FIG. 2;

FIG. 4 is a plan view of the frame of the rack assembly and the baskets of FIG. 1;

FIG. 5 is an enlarged plan view of a portion “B” of FIG. 3;

FIG. 6 is a plan view illustrating a state in which dishes are placed in the baskets of the dishwasher of FIG. 1;

FIG. 7 is a sectional view taken along line C-C in FIG. 6;

FIG. 8 is a sectional view illustrating a state in which dishes are placed in baskets of a dishwasher according to another embodiment; and

FIG. 9 is a sectional view illustrating a state in which dishes are placed in baskets of a dishwasher according to still another embodiment.

### DETAILED DESCRIPTION

Reference will now be made in detail to embodiments, examples of which are illustrated in the accompanying drawings. Wherever possible, like reference numerals have been used throughout the drawings to refer to the same or like parts.

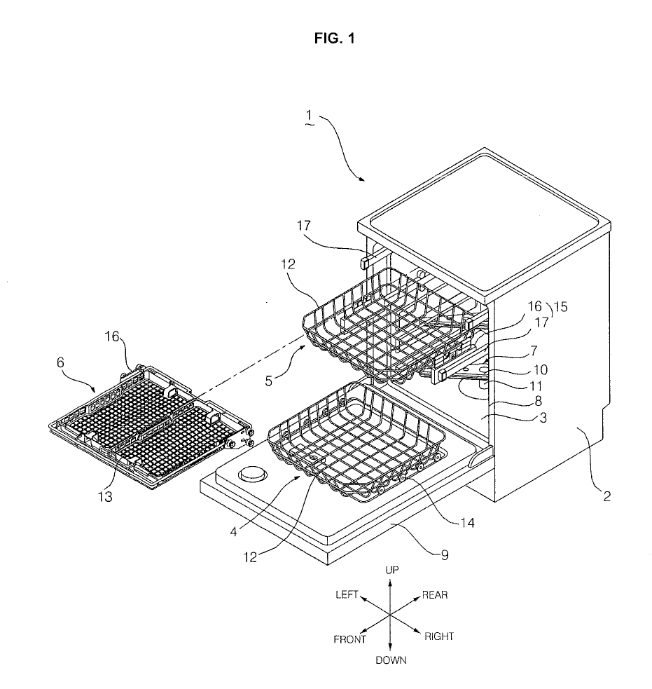

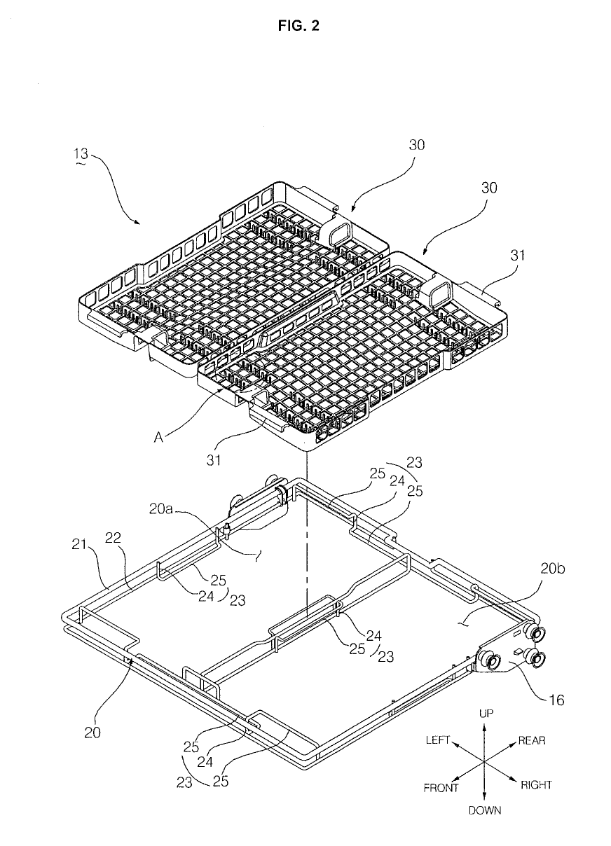

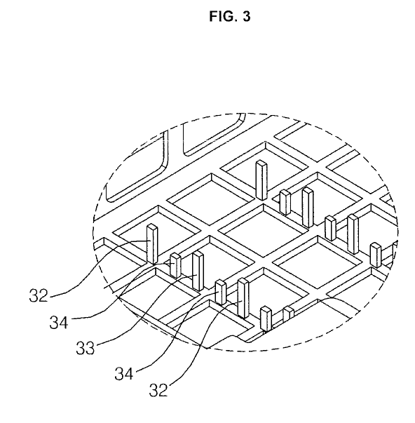

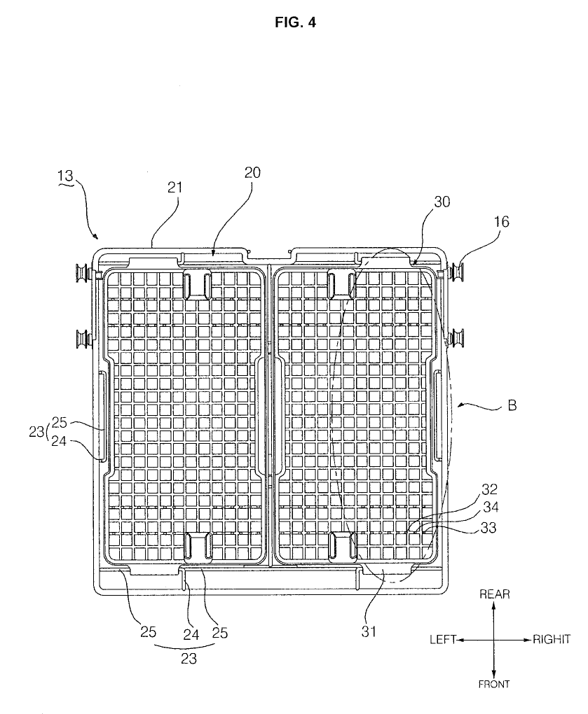

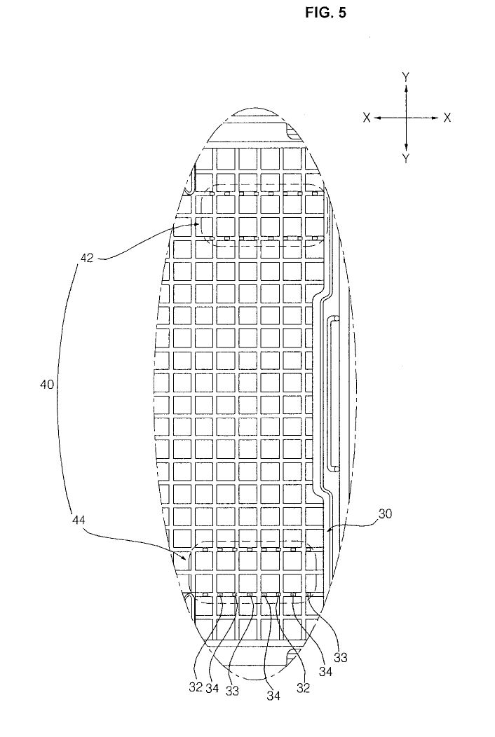

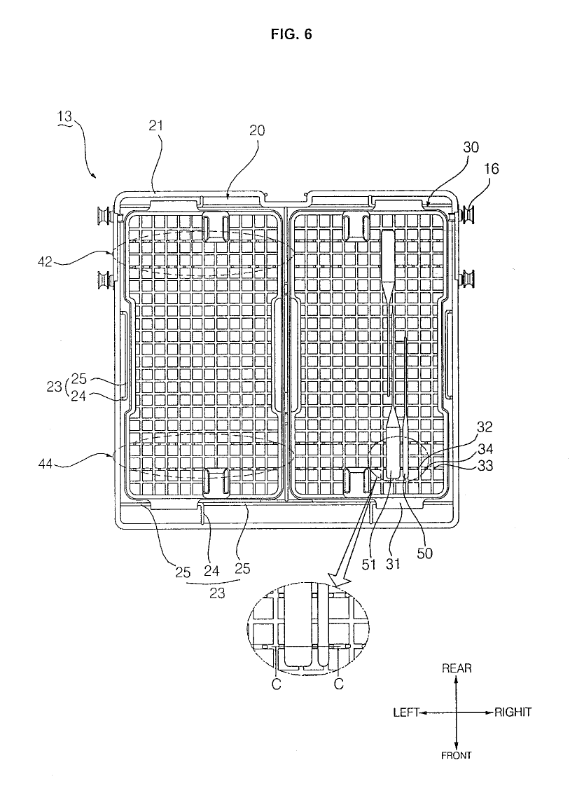

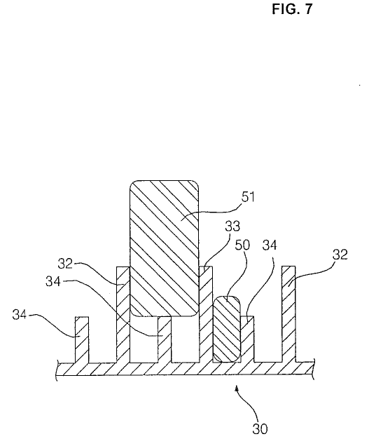

FIG. 1 is a front perspective view of a dishwasher according to an embodiment. FIG. 2 is an exploded perspective view of a frame of a rack assembly and baskets of the dishwasher of FIG. 1. FIG. 3 is an enlarged perspective view of a portion “A” of FIG. 2. FIG. 4 is a plan view of the frame of the rack assembly and the baskets of FIG. 1. FIG. 5 is an enlarged plan view of a portion “B” of FIG. 3. FIG. 6 is a plan view illustrating a state in which dishes are placed in the baskets of the dishwasher of FIG. 1. FIG. 7 is a sectional view taken along line C-C in FIG. 6.

Referring to FIG. 1, a dishwasher 2 may include a washing tub or space 3 provided in a cabinet 2 and having a cavity of a predetermined size, a plurality of rack assemblies 4, 5, and 6 configured to be inserted into and withdrawn from the washing tub 3 and in which dishes may be placed, and a wash water spraying apparatus 7 provided in the washing tub 3 to spray wash water onto the dishes placed in the rack assemblies 4, 5, and 6. An entrance or opening 8 through which the rack assemblies 4, 5, and 6 are inserted into and withdrawn from the washing tub 3 may be formed in a front surface of the cabinet 2 and the washing tub 3. A door 9 that opens and closes the entrance 8 may be rotatably attached to the cabinet 2. The door 9 may be rotatably opened and closed in a drop-down manner, as shown in FIG. 2.

The wash water spraying apparatus 7 may be configured to spray the wash water onto the dishes placed in the rack assemblies 4, 5, and 6. That is, the wash water spraying apparatus 7 may include a pump (not shown) provided between the cabinet 2 and the washing tub 3 to pump the wash water, a plurality of nozzles 10 that spray the wash water pumped by the pump onto the dishes, and a wash water channel 11 formed between the nozzles 10 and the pump. The nozzles 10 may be provided at a lower side and/or an upper side of the rack assemblies 4, 5, and 6.

Referring to FIGS. 1 and 6, the rack assemblies 4, 5, and 6 may be provided in the washing tub 3 spaced apart from each other in a vertical (columnwise) direction. That is, a first rack assembly 4 and a second rack assembly 5 may be provided at a lower portion and at a middle portion of the washing tub 3, such that tableware, such as dishes, bowels, and similar dishware may be accommodated therein. A third rack assembly 6 may be provided at an upper portion of the washing tub 3 such that cutleries 50 and 51 and culinary tools may be accommodated therein. However, one, two, three, or more rack assemblies may be provided in the washing tub 3 in accordance with the design conditions of the dishwasher 1 and the kinds of the dishes placed in the rack assemblies may vary.

The rack assemblies 4, 5, and 6 may include racks 12 and 13 in which the dishes may placed. Movement guides 14 and 15 may be provided for the racks 12 and 13 in the washing tub 3 to movably support the racks 12 and 13 in a forward and backward direction of movement. The racks 12 and 13 may be in the form of a grill so that the wash water sprayed from the wash water spraying apparatus 7 is transmitted to the dishes. The racks 12 of the first rack assembly 4 and the second rack assembly 5 may be formed of, for example, metal rods in the form of a grill. The rack 13 of the third rack assembly 6 may include baskets 30 molded in the form of a grill. The movement guide 14 of the first rack assembly 4 may include a plurality of wheels rotatably provided at a lower side of the rack 12 such that the rack 12 can move along inner surfaces of the door 9 and the washing tub 3. The movement guides 15 of the second rack assembly 5 and the third rack assembly 6 may include roller mechanisms 16 provided at lateral sides of the racks 12 and 13, and guide rails 17 provided at lateral sides of the washing tub 3 that guide movement of the roller mechanisms 16. Alternatively, the guide rails 17 may be provided at lateral sides of the racks 12 and 13, and the roller mechanisms 16 may be provided at lateral sides of the washing tub 3.

Referring to FIGS. 2 and 4, the third rack assembly 6 may include a frame 20 configured to be inserted into and withdrawn from the washing tub 3 by the movement guides 15, and one or more baskets 30 detachably provided on the frame 20. The one or more baskets 30 may include a plurality of dish holders to support dishware, such as cutleries 50 and 51 and/or culinary tools.

The frame 20 may be a rectangular frame made of, for example, steel rod. The frame 20 may include an upper frame 21 and a lower frame 22. The upper frame 21 and lower frame 22 may be rectangular in shape and may be separated from each other in the vertical direction. A connecting frame 23 may connect the upper frame 21 to the lower frame 22. The connecting frame 23 may include a plurality of supporting devices 25 on which the baskets 30 may be supported or received. The connecting frame 23 may include a plurality of connecting device 24 whose upper and lower sides are respectively connected to the upper frame 21 and the lower frame 22. The plurality of supporting devices 25 may protrude from the connecting device 24 toward an inner space defined by the frame 20 and on which the baskets 30 may be placed. If necessary, a plurality of frames 20 may be provided. The roller mechanisms 16 may be provided at right and left sides of the frame 20 to correspond to the guide rails 17 of the washing tub 3, respectively. Hereinafter, an embodiment in which a space defined by the frame 20 is partitioned into a right side space and a left side space such that two basket loading or receiving spaces 20a and 20b are formed will be described.

The baskets 30 may be basket-shaped molded products in which the cutleries 50 and 51 may be placed. The baskets 30 may be detachably provided in the basket receiving spaces 20a and 20b in the vertical direction. Each of the baskets 30 may have a plurality of supported devices 31 to be placed on the supporting devices 25 The baskets 30 may include a plurality of dish holders formed on bottoms of the baskets 30 and integrally formed therewith. The cutleries 50 and 51 and the culinary tools may be inserted and fixed to the dish holder.

Referring to FIGS. 3 to 6, the dish holders may respectively, include first, second, and third dish holders 32, 33, and 34 that protrude from the baskets 30 and support the cutleries 50 and 51. The first dish holders 32 and the second dish holders 33 may protrude from the bottoms of the baskets 30 upwardly, and may be separated from each other such that a large kitchen cutlery 51, such as a kitchen knife, may be inserted into and fixed by the first dish holders 32. The first dish holders 32 and the second dish holders 33 may have the same height. Alternative, the first dish holders 32 and the second dish holders 33 may have heights different from each other.

The third dish holders 34 may be provided between the first and second dish holders 32 and 33, such that table cutlery 50 thinner than the kitchen cutlery 51 may be inserted into and supported by the third dish holders 34. The table cutlery 50 may include, for example, a knife, a fork, or similar table cutlery. Hereinafter, a case in which the third dish holders 34 are provided in a single row between the first dish holders 32 and the second dish holders 33 will be described. The third dish holders 34 may have a height lower than the heights of the first and second dish holders 32 and 33. The protruding height of the third dish holders 34 may be equal to a height to which kitchen cutlery 51 inserted between the first dish holders 32 and the second dish holder 33 extends, such that the kitchen cutlery 51 that is inserted between the first and second dish holders 32 and 33 is stably supported by the third dish holders 34, as shown in FIG. 7.

On the other hand, the first, second, and third dish holders 32, 33, and 34 may be formed on the baskets 30 to face each other in a longitudinal direction of the cutleries 50 and 51 or the culinary tools in order to stably support the cutleries 50 and 51 or the culinary tools at a plurality of positions. Hereinafter, a case in which respective single pairs of the first, second, and third dish holders are separated from each other in the longitudinal direction of the cutleries 50 and 51 or the culinary tools will be described.

Referring to FIGS. 5 and 6, in this embodiment, a plurality of the first dish holder 32 and the second dish holders 33 may be alternately positioned along the row direction (the line X-X) formed by the first, second, and third dish holders 32, 33, and 34. The third dish holders 34 may be respectively provided between the first and second dish holders 33 and 34. Therefore, the first, second, and third dish holders 32, 33, and 34 form dish holder groups 40 that are arranged in single lines on the baskets 30. Each of the dish holder groups 40 may include a first dish holder group 42 provided at one side of the basket 30 and a second dish holder group 42 provided at the opposite side of the basket 30 in parallel to the first dish holder group 42.

The first and second dish holder groups 42 and 44 may be provided in the row direction (the line X-X) in an alternate manner with respect to a direction (the line Y-Y) where the first and second dish holder groups 42 and 44 are separated from each other so that the cutleries 50 and 51 do not interfere with each other. Hereinafter, the row directions (the line X-X) of the first and second dish holder groups 42 and 44 are referred to as right-to-left directions of the baskets 30, and the spacing directions (the line Y-Y) of the first and second dish holder groups 42 and 44 are referred to as front-to-rear directions of the baskets 30.

The first and second dish holder groups 42 and 44 may be configured to extend a predetermined distance in opposite directions along the right-to-left direction (the line X-X) or extend by different distances in any one direction in the right-to-left direction (the line X-X). A difference between the extended distances of the first and second dish holder groups 42 and 44 may be smaller than an extended distance difference between the first and second dish holders 32 and 33. Hereinafter, a case in which the first, second, and third dish holders 32, 33, and 34 of the second dish holder group 44 are provided to face each other in spaces formed among the first, second, and third dish holders 32, 33, and 34 of the first dish holder group 42 will be described. However, if the baskets 30 are sufficiently large, the first, second, and third dish holders 32, 33, and 34 constituting the first and second dish holder groups 42 and 44 may be provided to face each other.

Operation of a dishwasher constructed as described above according to embodiments will be described as follows.

First, the door 9 is opened to open the entrance 8 formed in the front side of the dishwasher 1, and the rack assemblies 4, 5, and 6 are withdrawn from the inside of the washing tub 3. Various kinds of dishes to be washed are placed in the rack assemblies 4, 5, and 6. Then, the rack assemblies 4, 5, and 6 are inserted into the washing tub 3 and the door 9 is closed to shield the entrance 8. As described above, after the dishes are accommodated in the washing tub 3, the dishwasher 1 is operated so that the dishes placed on the rack assemblies 4, 5, and 6 are washed by spraying the wash water from the wash water spraying apparatus 7.

As illustrated in FIGS. 1 and 6, when the rack assemblies 4, 5, and 6 of the dishwasher 1 are provided and the third rack assembly 6 provided at the upper portion of the washing tub 3 washes only the cutleries 50 and 51 or culinary tools, the cutleries 50 and 51 or culinary tools may be selectively inserted into and supported between the first, second, and third dish holders 32 formed in the baskets 30 of the third rack assembly 6. Referring to FIGS. 6 and 7, grips of the cutleries 50 and 51 may be selectively inserted between and fixed by two dish holders among the first, second, and third dish holders 32, 33, and 34 that are formed in the baskets 30. The grip of the large kitchen cutlery 51, such as a kitchen knife, is inserted between and is supported by the first and second dish holders 32 and 33. Therefore, the blade of the kitchen cutlery 51 is placed on the bottom of the basket 30 and the grip of the kitchen cutlery 51 is placed on the end of the third dish holders 34 such that the kitchen cutlery 51 is prevented from moving from side to side by the first and second dish holders 32 and 33. The third dish holders 34 compensate for the height difference between the blade and the grip of the kitchen cutlery 51. Moreover, the grip of the small kitchen cutlery 50, such as a knife, a fork, and similar cutlery, is inserted between and is supported by the first and third dish holders 32 and 34 or the second and third dish holders 33 and 34. The table cutlery 50 is placed on the bottoms of the baskets 30 to prevent the table cutlery 50 from moving from side to side by the first and second dish holders 32 and 34 or the second and third dish holders 33 and 34.

As described above, the third rack assembly 6 may selectively accommodate two kinds of the cutleries 50 and 51 of different sizes and shapes due to the first, second, and third dish holders 32, 33, and 34. The first, second, and third dish holders 32, 33, and 34 may be commonly used for the two kinds of the cutleries 50 and 51. Therefore, since the first, second, and third dish holders 32, 33, and 34 are used regardless of the kind of dishes, the space efficiency of the basket(s) 30 of the third rack assembly 6 is improved.

Further, since the first and second dish holder groups 42 and 44 in which the plurality of the first, second, and third dish holders 32, 33, and 34 may be respectively aligned in a line may be formed in the basket(s) 30 respectively and the first and second dish holder groups 42 and 44 may be alternately provided, the cutleries 50 and 51 that are provided in the first and second dish holder groups 42 and 44 may be also alternately provided. That is, the cutleries 50 and 51 that are inserted into the first dish holder groups 41 are respectively placed between the cutleries 50 and 51 placed in the second dish holder groups 44. Therefore, the cutleries 50 and 51 that are inserted into the first and second dish holder groups 42 and 44 may be prevented from interfering with each other.

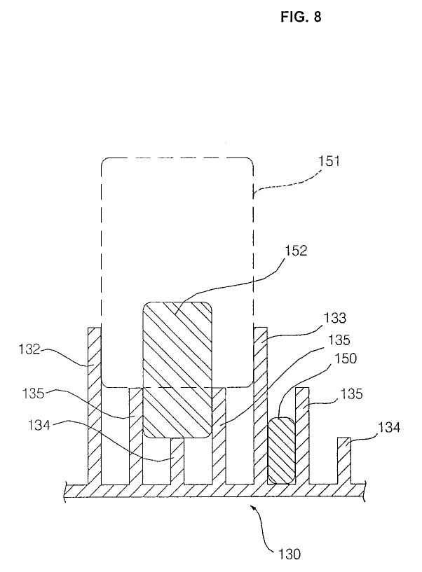

FIG. 8 is a sectional view illustrating a state in which dishes are placed in baskets of a dishwasher according to another embodiment. In FIG. 8, like reference numerals have been used to indicate like elements illustrated in FIG. 7. Hereinafter, only aspects of the dishwasher according to this embodiment different from those of the dishwasher previously discussed will be described.

The difference between basket(s) 130 of the dishwasher illustrated in FIG. 8 and the basket(s) 30 of the dishwasher 1 illustrated in FIGS. 1 to 7 is that single pairs of fourth dish holders 135 may be provided to face each other about the third dish holders 134 between first and second dish holders 132 and 133. Since the first, second, and third dish holders 132, 133, and 134 are identical to or similar to the first, second, and third dish holders 32, 33, and 34 illustrated in FIGS. 3 to 6, further description thereof will be omitted.

The fourth dish holders 135 may have a height lower than the heights of the first and second dish holders 132 and 133 and higher than the height of the third dish holders 134. The fourth dish holders 135 may be respectively provided between the first and third dish holders 132 and 134 and between the second and third dish holders 133 and 134.

Therefore, a thin table cutlery 150 may be provided between the first and fourth dish holders 132 and 135, between the second and fourth dish holders 133 and 135, and between the third and fourth dish holders 134 and 135. Moreover, kitchen cutleries 151 and 152 larger than the table cutlery 150 may be selectively provided between the first and second dish holders 132 and 133 and between the single pairs of fourth dish holders 135 in accordance with sizes and shapes.

The large kitchen cutlery 151 may be inserted between and supported by the first and second dish holders 132 and 133. In this case, the lower side of the kitchen cutlery 151 may be placed on the ends of the fourth dish holders 135 and may be stably supported by the fourth dish holders 135. The kitchen cutlery 152 smaller than the kitchen cutlery 151 inserted between the first and second dish holders 132 and 133 may be inserted between and supported by the pair of fourth dish holders 135. In this case, the lower side of the kitchen cutlery 152 is placed on the ends of the third dish holders 134 and is stably supported by the third dish holders 134.

In this embodiment, since the three kinds of the cutleries 150, 151 and 152 may be selectively supported by the first, second, third, and fourth dish holders 132, 133, 134, and 135 and the first, second, third, and fourth dish holders 132, 133, 134, and 135 may be commonly used for the three kinds of cutleries 150, 151, and 152, in comparison to the other embodiment, the space efficiency of the basket(s) 130 may be improved.

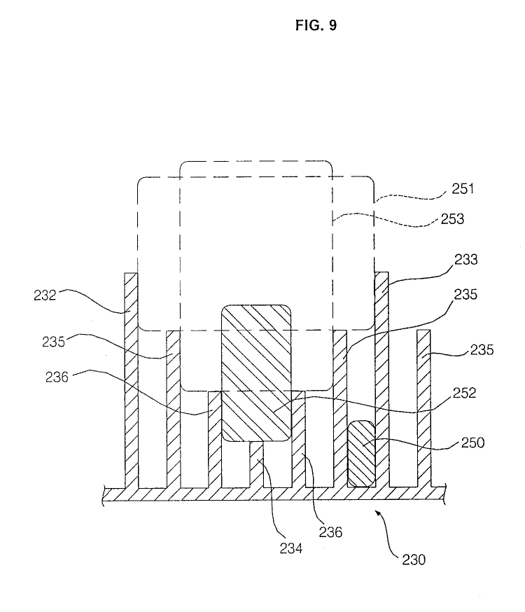

FIG. 9 is a sectional view illustrating a state in which dishes are placed in basket(s) of a dishwasher according to still another embodiment. In FIG. 9, like reference numerals have been used to indicate like elements illustrated in FIG. 7. Hereinafter, only aspects of the dishwasher according to this embodiment different from those of the dishwashers previously discussed will be described.

A difference between the basket(s) 230 of the dishwasher illustrated in FIG. 9 and the basket(s) 30 of the dishwasher 1 illustrated in FIGS. 1 to 7 lies in that a pair of fifth dish holders 235 and a pair of sixth dish holders 236 may be provided between first and second dish holders 232 and 233 to face each other based on third dish holders 234. Since the first, second, and third dish holders 232, 233, and 234 are similar to the first, second, and third dish holders 32, 33, and 34 illustrated in FIGS. 3 to 6, detailed description of the first, second, and third dish holders 232, 233, and 234 will be omitted.

The fifth and sixth dish holders 235 and 236 may be provided between the first and third dish holders 232 and 234 or the second and third dish holders 233 and 234 to be separated from each other by the same distance. The pair of fifth dish holders 235 may be close to the first and second dish holders 232 and 233. The pair of sixth dish holders 236 may be close to the third dish holders 234. Therefore, the fifth dish holders 235 may be provided between the first and sixth dish holders 232 and 236 and the second and sixth dish holders 234 and 236, respectively. The sixth dish holders 236 may be provided between the third and fifth dish holders 234 and 235.

The fifth and sixth dish holders 235 and 236 may be lower than the first and second dish holders 232 and 233 and higher than the third dish holders 234. The fifth dish holders 235 may be lower than the first and second dish holders 232 and 233 and higher than the sixth dish holders 236. The sixth dish holders 236 may be lower than the fifth dish holders 235 and higher than the third dish holders 234. That is, the fifth and sixth dish holders 235 and 236 may be formed so that the heights of the dish holders are gradually reduced from the first and second dish holders 232 and 233 toward the third dish holders 234.

Therefore, a thin table cutlery 250 may be provided between the first and fifth dish holders 232 and 235, between the second and fifth dish holders 233 and 235, between the fifth and sixth dish holders 235 and 236, and between the third and sixth dish holders 234 and 236. In addition, kitchen cutleries 251, 252, and 253 larger than the table cutlery 250 may be selectively provided between the first and second dish holders 232 and 233, between the pair of fifth dish holders 235, or the pair of sixth dish holders 236 in accordance with sizes and shapes.

The largest kitchen cutlery 251 may be inserted between and supported by the first and second dish holders 232 and 233. At this time, the lower part of the kitchen cutlery 251 may be supported on the ends of the fifth dish holders 235 to be stably supported by the fifth dish holders 235.

In addition, the kitchen cutlery 253 smaller than the kitchen cutlery 251 inserted between the first and second dish holders 232 and 233 may be inserted into and supported by the pair of fifth dish holders 235. At this time, the lower part of the kitchen cutlery 253 may be supported on the ends of the sixth dish holders 236 to be stably supported by the sixth dish holders 236.

In addition, the kitchen cutlery 252 smaller than the kitchen cutleries 251 and 253 inserted into the first and second dish holders 232 and 233 or the pair of fifth dish holders 235 may be inserted into and supported by the pair of sixth dish holders 236. At this time, the lower part of the kitchen cutlery 252 may be supported on the ends of the third dish holders 234 to be stably supported by the third dish holders 234.

According to this embodiment, since four kinds of cutleries 250, 251, 252, and 253 may be selectively placed by the first, second, third, fifth, and sixth dish holders 232, 233, 234, 235, and 236 and the first, second, third, fifth, and sixth dish holders 232, 233, 234, 235, and 236 may be commonly used for the four kinds of cutleries 250, 251, 252, and 253, the space efficiency of the basket(s) 230 may be improved.

According to embodiments disclosed herein, dish holders to which the cutleries and the culinary tools may be fixed may be formed in the racks of one and two-column rack assemblies. In addition, according to embodiments, at least three dish holders may have different heights so that a pair of dish holders are provided between the first and second dish holders based on the third dish holders to face each other.

As described above, in the dishwasher according to embodiments disclosed herein, since the dish holders in which dishes having different sizes and shapes are selectively provided are formed in the rack assemblies, various kinds of dishes may be washed together and the various kinds of dishes may be freely provided in the rack assemblies so that space efficiency is improved.

In addition, in the dishwasher according to embodiments disclosed herein, since kitchen cutleries, such as a kitchen knife, as well as the table cutleries, such as a knife and fork are selectively provided in the dish holders of the rack assemblies, the marketability of the dishwasher is improved in circumstances where kitchen cutleries, such as the kitchen knives, are frequently used.

The dishwasher according to embodiments disclosed herein is capable of washing various types of dishes selectively placed in dish holders of a rack assembly, and the space efficiency of the rack assembly is improved.

In accordance with one embodiment disclosed herein, there is provided a dishwasher that includes a rack assembly drawably provided in a washing tub, first, second, and third dish holders that are provided in the rack assembly and in which dishes of different sizes and shapes may be selectively inserted and are supported, wherein the first dish holder and the second dish holder are separated from each other, and the third dish holder is provided between the first and second dish holders and has a height different from those of the first and second dish holders.

The first dish holder and the second dish holder may have the same height. Further, the third dish holder may have a height lower than the heights of the first and second dish holders. The third dish holder may have a height where the dishes that are inserted between the first and second dish holders are placed. On the other hand, a plurality of the first and second dish holders may be alternately aligned in a line, and a plurality of third dish holders may be respectively provided between the first and second dish holders.

The first, second, and third dish holders may be provided in a plurality of rows on the rack assembly in parallel to each other, and the first, second, and third dish holders that are respectively provided in the plurality of rows may be provided to face each other. Further, the first, second, and third dish holders that are respectively provided in the plurality of rows may be alternately provided. The dishwasher may further include a plurality of dish holders of a height different from those of the first, second, and third dish holders may be provided between the first and third dish holders and between the second and third dish holders to face each other about the third dish holder.

In accordance with another embodiment disclosed herein, there is provided a dishwasher that includes a rack assembly drawably provided in a washing tub, and a plurality of dish holders that are provided in the rack assembly and in which dishes may be alternately placed. The dish holders may include a plurality of dish holder groups respectively aligned in a line in the rack assembly. The plurality of dish holder groups may be provided in the rack assembly to be separated from each other. The dish holder groups may be alternately provided in the row directions of the dish holder groups such that the dishes placed in the dish holders do not interfere with each other.

Further, the dish holder groups may be provided in parallel to each other in the rack assembly. The dish holder groups may be provided such that odd rows and even rows of the dish holder groups are alternately provided in the row directions of the dish holder groups to prevent the interference between the dishes that are placed in the dish holders.

The dish holders may include insertion single pairs of protrusions being separated from each other in which table cutleries or culinary tools may be inserted and are fixed. The dish holder groups may be configured such that the dish holders are aligned with the direction where the single pairs of insertion protrusions are separated from each other. The rack assembly may include a frame that is drawably provided in an upper side of the washing tub, and a basket that is detachably mounted to the frame and in which the dish holders are formed. The dish holders may be integrally formed with the baskets, such as by molding.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A dishwasher, comprising:
a case having a dishwashing space disposed therein; and
at least one rack assembly configured to hold dishware therein and to be inserted into and removed from the case, wherein the at least one rack assembly comprises a frame and at least one basket configured to be supported by the frame and wherein the at least one basket comprises:
a plurality of dish holders configured to hold dishes or utensils securely in the at least one basket, wherein the plurality of dish holders comprises first and second dish holders having different heights disposed adjacent to one another.

2. The dishwasher of claim 1, wherein the plurality of dish holders extends up from a bottom surface of the at least one basket.

3. The dishwasher of claim 1, wherein one of the first dish holders is disposed between two of the second dish holders such that the dish holders alternate in height.

4. The dishwasher of claim 1, wherein a plurality of the dish holders is provided at a first end of the at least one basket and a plurality of dish holders is provided at a second end of the at least one basket.

5. The dishwasher of claim 4, wherein the plurality of dish holders at the first end is offset from the plurality of dish holders at the second end.

6. The dishwasher of claim 4, wherein the plurality of dish holders at the first end extends parallel to the plurality of dish holders at the second end.

7. The dishwasher of claim 1, wherein the plurality of dish holders further includes a plurality of third dish holders having a height different from the first and second dish holders.

8. The dishwasher of claim 7, wherein the plurality of dish holders is arranged in a line and wherein a second dish holder is disposed between each of a first and third dish holder.

9. The dishwasher of claim 7, wherein the plurality of dish holders is arranged in a line of repeated decreasing then increasing height.

10. The dishwasher of 7, wherein the plurality of dish holders further includes a plurality of fourth dish holders having a height different from the first, second, and third dish holders.

11. The dishwasher of claim 10, wherein the plurality of dish holders is arranged in a line of repeated decreasing then increasing height.

12. The dishwasher of claim 1, wherein the plurality of dish holders is arranged in parallel lines of dish holders.

13. A dishwasher, comprising:
a case having a dishwashing space disposed therein; and
at least one rack assembly configured to hold dishware therein and to be inserted into and removed from the case, wherein the at least one rack assembly comprises a frame and at least one basket configured to be supported by the frame, and wherein the at least one basket has a curved bottom.

14. The dishwasher of claim 13, wherein a first portion of the curved bottom of the at least one basket extends lower than a second portion of the curved bottom of the at least one basket.

15. A rack assembly for a dishwasher, comprising:
a frame; and
at least one basket configured to be supported by the frame, wherein the at least one basket comprises:
a plurality of dish holders configured to hold dishes or utensils securely in the at least one basket, wherein the plurality of dish holders includes first and second dish holders having different heights disposed adjacent to one another.

16. The rack assembly of claim 15, wherein the plurality of dish holders extends up from a bottom surface of the at least one basket.

17. The rack assembly of claim 15, wherein one of the first dish holders is disposed between two of the second dish holders such that the dish holders alternate in height.

18. The rack assembly of claim 15, wherein a plurality of the dish holders is provided at a first end of the at least one basket and a plurality of dish holders is provided at a second end of the at least one basket.

19. The rack assembly of claim 18, wherein the plurality of dish holders at the first end is offset from the plurality of dish holders at the second end.

20. The rack assembly of claim 18, wherein the plurality of dish holders at the first end extends parallel to the plurality of dish holders at the second end.

21. The rack assembly of claim 15, wherein the plurality of dish holders further includes a plurality of third dish holders having a height different from the first and second dish holders.

22. The rack assembly of claim 21, wherein the plurality of dish holders is arranged in a line and wherein a second dish holder is disposed between each of a first and third dish holder.

23. The rack assembly of claim 21, wherein the plurality of dish holders is arranged in a line of repeated decreasing then increasing height.

24. The rack assembly of 21, wherein the plurality of dish holders further includes a plurality of fourth dish holders having a height different from the first, second, and third dish holders.

25. The rack assembly of claim 24, wherein the plurality of dish holders is arranged in a line of repeated decreasing then increasing height.

26. The rack assembly of claim 15, wherein the plurality of dish holders is arranged in parallel lines of dish holders.

27. A rack assembly for a dishwasher, comprising:
a frame; and
at least one basket configured to be supported by the frame, wherein the at

28. The rack assembly of claim 27, wherein a first portion of the curved bottom of the at least one basket extends lower than a second portion of the curved bottom of the at least one basket.
